(19) United States
(12) Patent Application Publication
(10) Pub. No.: US 2018/0285795 A1
(43) Pub. Date: Oct. 4, 2018

(54) METHOD AND DEVICE FOR RISK ANALYSIS USING RISK RELATIONSHIP MAPPING IN SUPPLY CHAIN NETWORKS

(71) Applicant: WIPRO LIMITED, BANGALORE (IN)

(72) Inventor: SELVAKUBERAN KARUPPASAMY, CHENNAI (IN)

(21) Appl. No.: 15/474,515

(22) Filed: Mar. 30, 2017

(51) Int. Cl. G06Q 10/06; G06F 17/30

(52) U.S. Cl. CPC G06Q 10/0635; G06F 17/3074; G06F 17/30684

(57) ABSTRACT

A method and device for performing risk analysis using risk relationship mapping in a supply chain network is disclosed. The method includes creating a plurality of risk categories within the supply chain network. The method further includes creating a multi-dimensional risk relationship map for the plurality of risk categories that includes at least one first-dimension including a first set of risk relationships and at least one second dimension including a second set of risk relationships. The method includes assigning an impact priority to each of the first set of risk relationships and each of the second set of risk relationships. The method further includes optimizing the first set of risk relationships and the second set of risk relationships in response to the assigning.

### TECHNICAL FIELD

This disclosure relates generally to supply chain networks and more particularly to method and device for risk analysis using risk relationship mapping in supply chain networks.

### BACKGROUND

Supply chain management is the streamlining of a business' supply-side activities to maximize customer value and to gain a competitive advantage in the marketplace. Supply chain management represents an effort by suppliers to develop and implement supply chains that are as efficient and economical as possible. It represents a conscious effort by the supply chain firms to develop and run supply chains in the most effective and efficient ways possible. Supply chain activities cover everything from product development, sourcing, production, and logistics, as well as the information systems needed to coordinate these activities. Currently, there are many challenges to provide effective risk analysis and risk management in the supply chain. There are challenges related to identification of risks, prioritizing the risks based on their impact, managing risks without introducing new risks in supply chain, and proactively manage the future risks for effective decision making.

The losses in the supply chain in the market are due to the risk or disruption in the supply chain. Hence, companies adopt their own methodologies for managing the supply chain risks. Supply chain risk management is a crucial process for many companies, and many companies strive to have the most optimized supply chain, because it usually translates to lower costs for the company.

Conventional risk management techniques match risks with appropriate solutions in a database that includes pre-stored static mapping. Thus, whenever the database needs to be updated, a domain expert is required, which is a time consuming process and thus results in customer dissatisfaction or in a worst case scenario causes the customer to leave the supply chain altogether.

### SUMMARY

In one embodiment, a method of performing risk analysis using risk relationship mapping in a supply chain network is disclosed. The method includes creating, by a risk analyzing device, a plurality of risk categories based on a plurality of supply chain inputs within the supply chain network, wherein each of the plurality of risk categories comprise a plurality of risk components, and wherein each of the plurality of risk components has an associated plurality of risks; creating, by the risk analyzing device, a multi-dimensional risk relationship map for the plurality of risk categories comprising at least one first-dimension and at least one second dimension, wherein each of the at least one first-dimension comprises a first set of risk relationships amongst associated plurality of risks within one of the at least one risk component and each of the at least one second-dimension comprises a second set of risk relationships amongst associated plurality of risks across at least two of the plurality of risk components; assigning, by the risk analyzing device, an impact priority to each of the first set of risk relationships and each of the second set of risk relationships, wherein an impact priority is assigned to a risk relationship based on impact of the risk relationship on the supply chain network; and optimizing, by the risk analyzing device, the first set of risk relationships and the second set of risk relationships in response to the assigning.

In another embodiment, a risk analyzing device for performing risk analysis using risk relationship mapping in a supply chain network is disclosed. The risk analyzing device includes a processor; and a memory communicatively coupled to the processor, wherein the memory stores processor instructions, which, on execution, causes the processor to create a plurality of risk categories based on a plurality of supply chain inputs within the supply chain network, wherein each of the plurality of risk categories comprise a plurality of risk components, and wherein each of the plurality of risk components has an associated plurality of risks; create a multi-dimensional risk relationship map for the plurality of risk categories comprising at least one first-dimension and at least one second dimension, wherein each of the at least one first-dimension comprises a first set of risk relationships amongst associated plurality of risks within one of the at least one risk component and each of the at least one second-dimension comprises a second set of risk relationships amongst associated plurality of risks across at least two of the plurality of risk components; assign an impact priority to each of the first set of risk relationships and each of the second set of risk relationships, wherein an impact priority is assigned to a risk relationship based on impact of the risk relationship on the supply chain network; and optimize the first set of risk relationships and the second set of risk relationships in response to the assigning.

In yet another embodiment, a non-transitory computer-readable storage medium is disclosed. The non-transitory computer-readable storage medium has instructions stored thereon, a set of computer-executable instructions causing a computer comprising one or more processors to perform steps comprising creating, by a risk analyzing device, a plurality of risk categories based on a plurality of supply chain inputs within the supply chain network, wherein each of the plurality of risk categories comprise a plurality of risk components, and wherein each of the plurality of risk components has an associated plurality of risks; creating, by the risk analyzing device, a multi-dimensional risk relationship map for the plurality of risk categories comprising at least one first-dimension and at least one second dimension, wherein each of the at least one first-dimension comprises a first set of risk relationships amongst associated plurality of risks within one of the at least one risk component and each of the at least one second-dimension comprises a second set of risk relationships amongst associated plurality of risks across at least two of the plurality of risk components; assigning, by the risk analyzing device, an impact priority to each of the first set of risk relationships and each of the second set of risk relationships, wherein an impact priority is assigned to a risk relationship based on impact of the risk relationship on the supply chain network; and optimizing, by the risk analyzing device, the first set of risk relationships and the second set of risk relationships in response to the assigning.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for risk analysis in a supply chain network, in accordance with an embodiment.

FIG. 2 is a block diagram illustrating various modules within a memory of a risk analyzing device configured to perform risk analysis using risk relationship mapping in a supply chain network, in accordance with an embodiment.

FIG. 3 illustrates a flowchart of a method for performing risk analysis using risk relationship mapping in a supply chain network, in accordance with an embodiment.

FIG. 4 illustrates a flowchart of a method for performing risk analysis using risk relationship mapping in a supply chain network, in accordance with another embodiment.

FIG. 5 illustrates a flowchart of a method of categorizing a user query and creating new risk relationships based on the user query, in accordance with an embodiment.

FIG. 6 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

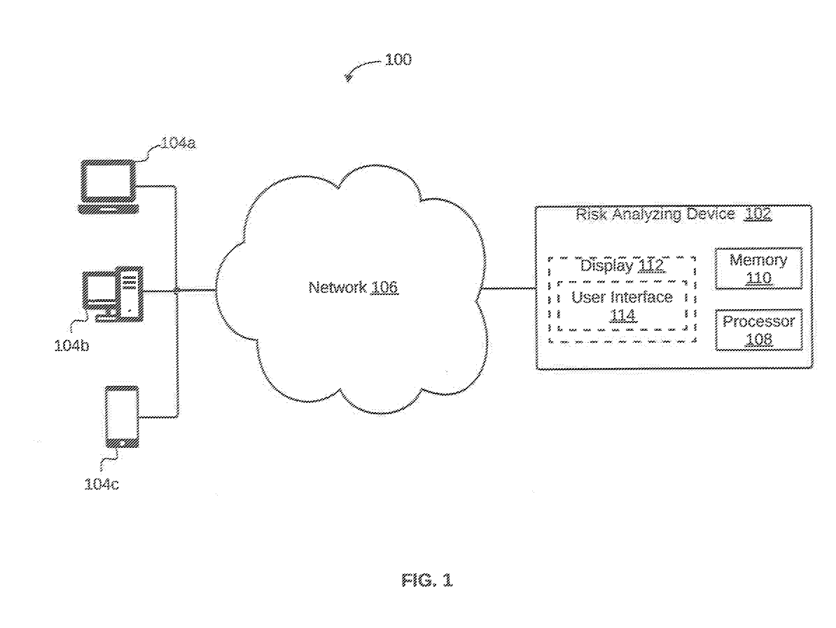

Additional illustrative embodiments are listed below. In one embodiment, a system 100 for performing risk analysis in a supply chain network is illustrated in FIG. 1. System 100 includes a risk analyzing device 102 that performs risk analysis in the supply chain network. The supply chain network includes a plurality of computing devices 104 (for example, a laptop 104a, a desktop 104b, and a smart phone 104c) and a network 106. Other examples of plurality of computing devices 104, may include, but are not limited to a phablet and a tablet. Network 106 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

Raw material suppliers, manufacturers, whole-salers, retailers, distributors, and customers in the supply chain network may access plurality of computing devices 104. The customers may vary depending upon the type of supply chain network. A customer facing an issue within the supply chain network may provide user queries via one or more of plurality of computing devices 104. A user query may either be an audio message or a text message that is provided via an SMS, an email, or through a messenger (for example, WHATSAPP® or FACEBOOK® messenger).

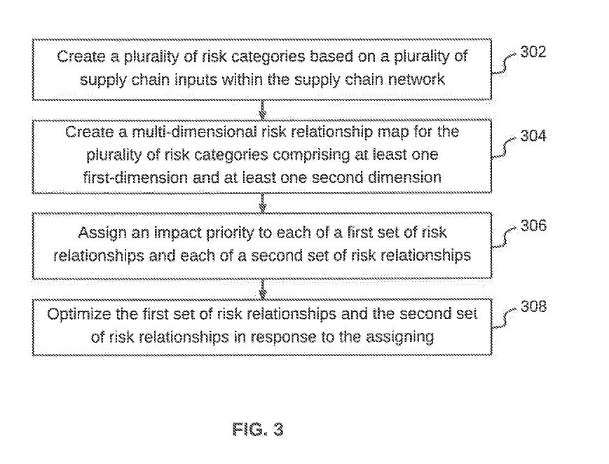

Risk analyzing device 102 additionally receives supply chain inputs that may include one or more of, but are not limited to supply chain contributors, supply chain parameters, or supply chain data sources that are selected based on the supply chain parameters. The supply chain parameters, for example, may include one or more of supply, demand, transportation, process, storage, information, finance, or environment. Based on the supply chain inputs and the user queries, risk analyzing device 102 performs risk analysis in the supply chain network. This is further explained in detail in conjunction with FIG. 3.

To this end, risk analyzing device 102 includes a processor 108 that is communicatively coupled to a memory 110, which may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

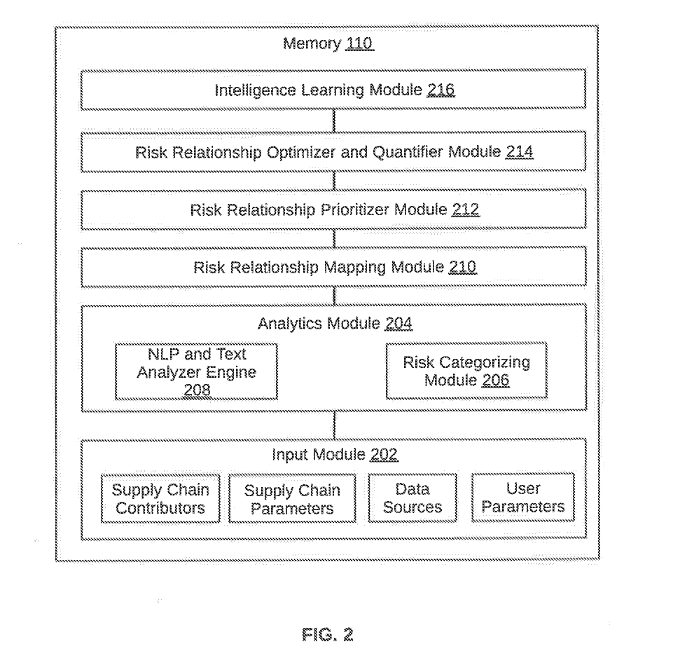

Memory 110 further includes various modules that enable risk analyzing device 102 to perform risk analysis in the supply chain network. These modules are explained in detail in conjunction with FIG. 2. Risk analyzing device 102 may further include a display 112 having a User Interface (UI) 114 that may be used by a user or an administrator to provide inputs and to interact with risk analyzing device 102. Display 112 may further be used to display result of the risk analysis performed.

Referring now to FIG. 2, a block diagram of various modules within memory 110 of risk analyzing device 102 configured to perform risk analysis using risk relationship mapping in a supply chain network is illustrated, in accordance with an embodiment. An input module 202 receives a plurality of supply chain inputs associated with the supply chain network. The plurality of supply chain inputs may include, but are not limited to supply chain contributors, supply chain parameters, and supply chain data sources. The supply chain contributors may Include, but are not limited to raw material suppliers, manufacturers, whole-salers, retailers, distributors, and the customers. Customers may vary depending upon the type of supply chain network. Further, the supply chain parameters include, but are not limited to supply, demand, transportation, process, storage, information, finance, and environment. The supply chain data sources are selected based on the supply chain parameters. In addition to receiving the plurality of supply chain parameters, input module 202 receives user query as user parameters.

Input module 202 is coupled to an analytics module 204 that further includes a risk categorizing module 206 and a Natural Language Processing (NLP) and text analyzer engine 208. Based on the supply chain inputs, risk categorizing module 206 creates a plurality of risk categories in order to categorize risks in the supply chain network. Each risk category includes a plurality of risk components and each risk component further has an associated plurality of risks. This is further explained in detail in conjunction with FIG. 3.

A risk relationship mapping module 210 creates a multi-dimensional risk relationship map for the plurality of risk categories. The multi-dimensional risk relationship map includes one or more first-dimensions and one or more second dimensions. Each of the one or more first-dimensions includes a first set of risk relationships and each of the one or more second-dimensions includes a second set of risk relationships. This is further explained in detail in conjunction with FIG. 3.

Thereafter, risk relationship prioritizer module 212 assigns an impact priority to each of the first set of risk relationships and each of the second set of risk relationships. An impact priority is assigned to a risk relationship based on impact of the risk relationship on the supply chain network. A risk relationship optimizer and quantifier module 214 optimizes the first set of risk relationships and the second set of risk relationships based on the assigned impact priority. This is further explained in detail in conjunction with FIG. 3.

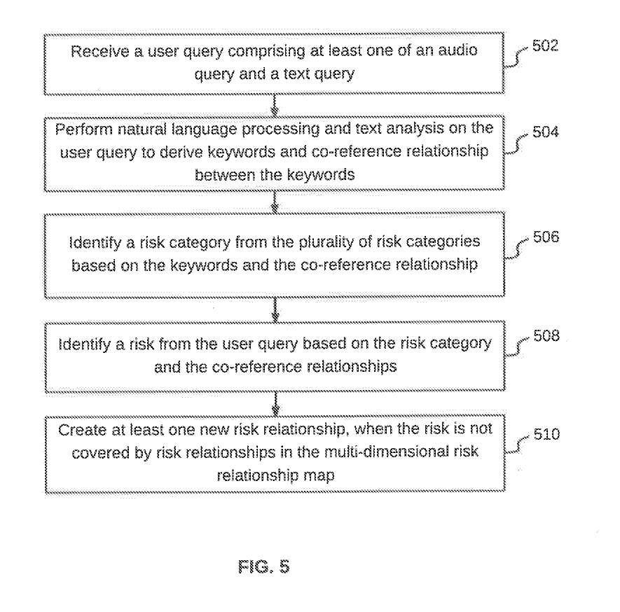

When input module 202 receives the user query, NLP and text analyzer engine 208 analyses the user query to derive keywords and co-reference relationships amongst the keywords. Thereafter, based on the keywords and the co-reference relationship, risk categorizing module 206 identifies a risk category from the plurality of risk categories, in which the user query should be categorized into. Risk relationship mapping module 210 then identifies a risk from the user query based on the risk category and the co-reference relationships. When the risk is not covered by the risk relationships in the multi-dimensional risk relationship map, risk relationship mapping module 210 creates one or more new risk relationships. This is further explained in detail in conjunction with FIG. 5.

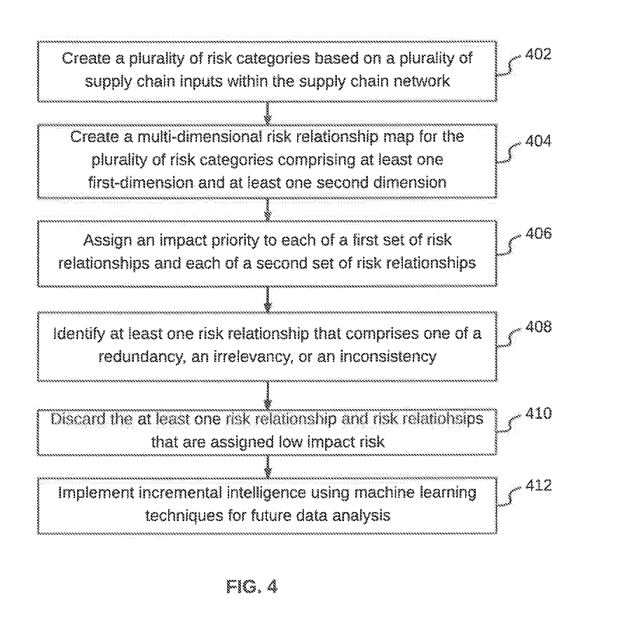

An intelligence learning module 216 implements incremental intelligence using machine learning techniques for future data analysis. This is further explained in detail in conjunction with FIG. 4.

Referring to FIG. 3, a flowchart of a method for performing risk analysis using risk relationship mapping in a supply chain network is illustrated, in accordance with an embodiment. To initialize the system in the supply chain network, risk analyzing device 102 receives a plurality of supply chain inputs associated with the supply chain network. The plurality of supply chain inputs may include, but are not limited to supply chain contributors, supply chain parameters, and supply chain data sources, the supply chain data sources being selected based on the supply chain parameters. It will be apparent to a person skilled in the art that different supply chain networks would have different contributors and parameters and would thus vary based upon the supply chain network used within an enterprise. By way of an example, in case of a product manufacturing supply chain network, the supply chain parameters may include, but are not limited to one or more of supply, demand, transportation, process, storage, information, finance, or environment.

At step 302, risk analyzing device 102 creates a plurality of risk categories based on the plurality of supply chain inputs, which include the supply chain parameters, in order to categorize risks in the supply chain network. Each risk category includes a plurality of risk components and each risk component further has an associated plurality of risks. The risk components for a risk category and risks associated with each of these risk components may be predefined based on the supply chain network and may be modified and augmented based on analysis of different user queries received by risk analyzing device 102. Risk components may be clustered into a risk category in such a way that risk components in the same risk category are more similar to each other than to those in other risk categories. Categorizing includes finding a structure in a collection of unlabeled data.

In case of a product manufacturing supply chain network, risk analyzing device 102 may, for example, create three risk categories, i.e., an external to supply chain risk category, an internal to supply chain risk category, and a management related risk category. Each of these risk categories include one or more risk components associated with the product manufacturing supply chain network. These risk categories along with their associated risk components are depicted in Table 1 given below.

TABLE 1

| Risk Category | Risk Components |
|---|---|
| Management Related | Supplier, Demand, Transportation |
| Internal to supply chain | Process, Storage, Information |
| | Technology |
| External to supply chain | Finance, Environment |

Each risk component for a risk category in the product supply chain network further has an associated plurality of risks. Risks associated with the risk components of Table 1 are depicted in Table 2 given below:

TABLE 2

| Risk Component | Associated Risks |
|---|---|
| Supplier | Monopoly, Outsourcing, Supplier |
| | Outage |
| Demand | Demand variability, Competitors, |
| | Product Life Cycle |
| Transportation | Reliability, Vehicle capacity, Service |
| | Flexibility |
| Process | Capacity Flexibility, Process Quality, |
| | Reliability, Unavailable Components |
| Storage | Space, Storage Condition, |
| | Maintenance |
| Information Technology | Visibility, Bullwhip Effect, Infrastructure |
| Finance | Insurance, Overhead Cost, Exchange, |
| | Capital Investment |
| Environment | Legal, Political, Social, Labor, and |
| | Natural Disaster |

At step 304, risk analyzing device 102 creates a multi-dimensional risk relationship map for the plurality of risk categories. The multi-dimensional risk relationship map includes one or more first-dimensions, such that, each first-dimension includes a first set of risk relationships that are created amongst associated plurality of risks within one of the one or more risk components. In other words, for a given risk component, a first set of risk relationships would include risk relationships amongst risks that are associated with that risk component only. These risk relationships would come under one of the one or more first dimensions within the multi-dimensional risk relationship map. In other words, risk relationships amongst the risks associated with this risk component will be one of the first dimension and thus each risk component would separately represent one such first dimension. Additionally, each risk relationship would include one or more risks. Thus, there may be no upper limit to the number of risks that a risk relationship may include. This however may be capped by an administrator based on computational capability of systems within the enterprise.

By way of an example, referring back to table 1 and table 2, we consider the “Transportation” risk component within the “Management Related” risk category. The “Transportation” risk component has the following associated risks: Reliability, Vehicle capacity, and Service Flexibility. Thus, a first set of relationships may include relationships amongst these risk and forms one of the first dimensions within multi-dimensional risk relationship map. A risk relationship, for example, may be that: “Service Flexibility” within the supply chain network is adversely affected when the “Vehicle Capacity” is inadequate.

The multi-dimensional risk relationship map additionally include one or more second dimensions, such that, each second-dimension includes a second set of risk relationships amongst associated plurality of risks across two or more of the plurality of risk components. Thus, in contrast to a first dimension, which was within one risk component, a second-dimension is across at least two risk components.

By way of an example, referring back to table 1 and table 2, a second dimension may be created across two risk components, i.e., “Storage” and “Transportation.” This second dimension would thus include a second set of risk relationships amongst one or more of risks associated with “Storage” (i.e., Space, Storage Condition, and Maintenance) and one or more of risks associated with “Transportation” (Reliability, Vehicle capacity, and Service Flexibility). One Such risk relationship within this second set of risk relationships, for example, may be between “Space” and “Vehicle Capacity.” In order to fix the risk of shortage in “Space,” Just in Time (JIT) arrival of goods may be implemented. However, this may further lead to the risk of shortage in “Vehicle Capacity.” In other words, the risk of shortage in “Space” can be fixed by introducing JIT methodology, only when the risk of “Vehicle Capacity” is mitigated or controlled. By way of another example, for the risk component “Supplier,” “Supplier Outage” is one of the associated risks. There may be multiple reasons that may lead to this risk. These multiple reasons may be different risks that fall under other risk components and may include Natural disasters (Environmental risk component), shortage of raw materials (Process risk component), overhead cost (Finance Risk component), or labor issues (Environmental risk component).

In an embodiment, a risk relationship (within the first and second set of risk relationships) may be an implication expression of the form X→Y, where X and Y are risks that are disjoint item sets, i.e., X∩Y=ø. The inference made by a risk relationship may not necessarily imply causality. Instead, the risk relationship may indicate a strong co-occurrence relationship between items in the antecedent (X) and consequent (Y) of risk relationship. The reason being that causality requires knowledge about the causal and effect attributes within a relationship and may typically involve relationships occurring over time. By way of an example, such a relationship may be: “Ozone depletion leads to global warming.”

The first set of relationships and the second set of relationships thus enable risk analyzing device 102 to identify attributes or effects that constitute a given risk. The identification is important to formulate a solution that mitigates the given risk. In an embodiment, only those risk relationships are created that would be relevant to the supply chain network under consideration and risks that are beyond human control (for example natural disorder and other environmental conditions) may not be considered while creating risk relationships.

Once the multi-dimension relationship map is created, risk analyzing device 102, at step 306, assigns an impact priority to each of the first set of risk relationships and each of the second set of risk relationships. An impact priority is assigned to a risk relationship based on impact of the risk relationship on the supply chain network. The impact priority may include one of a high impact risk, a low impact risk, or a medium impact risk. In an embodiment, in order to assign the impact priority, risk analyzing device 102 first identifies whether a particular risk relationship includes a direct impact or an indirect impact on the supply chain network. To this end, risk analyzing device 102 determines consequences for each risk relationship in the multi-dimension relationship map and the effects that each risk relationship will create in the supply chain network.

Based on the above analysis, risk analyzing device 102 identifies risk relationships that include a direct impact as having a high impact risk. By way of an example, in the risk relationship between “Demand” for goods and “Supplier” for the goods, Demand is dependent on the Supplier of goods. Thus, this risk relationship is identified as a high impact risk. Further, risk analyzing device 102 identifies risk relationships that include an indirect impact as having a medium impact risk. Though these risk relationships do not include a direct impact, but do affect profitability of the supply chain network. By way of an example, we consider the risk relationship between “Demand” for goods and “Transportation” facilities. In this risk relationship, improper transportation facilities have an indirect impact on the Demand for goods, as the Supplier of goods needs proper Transportation facilities to facilitate a smooth supply of goods. All other risk relationships that neither include a direct impact nor an indirect impact are identified as having low impact risk. Examples of such risk relationships may include relationship risks that are neutral and won't be affecting the supply chain network or relationship risks that are out of control.

Assigning an impact priority to each risk relationship is essential, as the multi-dimension risk relationship map includes a plethora of risk relationships owing to numerous permutations and combinations amongst risks within the supply chain network. Prioritization plays a vital role in optimizing memory requirement while performing risk analysis within the supply chain network.

Thereafter, at step 308, risk analyzing device 102 optimizes the first set of risk relationships and the second set of risk relationships in response to assigning the impact priority. In other words, risk relationships are optimized based on the impact priority (high impact risk, medium impact risk, or low impact risk) assigned by risk analyzing device 102. In an embodiment, in order to optimize risk relationships, risk analyzing device 102 may quantify risk relationships based on a likelihood score (which is a function of a total number of prior issues that mapped on to a risk relationship within a given span of time) and a consequence score (which is a function of the impact priority assigned to a risk relationship or in other words, the direct impact of a risk relationship on the supply chain network). This quantification is enabled with the help of an intelligent system using machine learning techniques.

Risk analyzing device 102 optimizes risk relationships by discarding all those risk relationships that have been assigned a low impact risk. When impact priority assigned to two or more risk relationships is the same, risk analyzing device 102 looks into the risk components associated with each risk relationship. When the associated risk components are the same, then risk analyzing device 102 looks at the impact priority assigned to these risk components. Risk analyzing device 102 additionally discards risk relationships that are redundant, risk relationships that are inconsistent (i.e., outcome of these relationship rules remain same irrespective of factors of a given attribute), and risk relationships that are irrelevant. As a result of optimizing, utilization of memory and space becomes more efficient and cost effective. In absence of optimizing, the huge number of risk relationships would consume enormous amount of memory and computational resources.

Referring now to FIG. 4, a flowchart of a method of performing risk analysis based on risk relationship mapping in a supply chain network is illustrated, in accordance with another embodiment. At step 402, risk analyzing device 102, creates a plurality of risk categories based on a plurality of supply chain inputs within the supply chain network. At step 404, risk analyzing device 102 creates a multi-dimensional risk relationship map for the plurality of risk categories, which includes one or more first-dimensions and one or more second dimensions. At step 406, risk analyzing device 102 assigns an impact priority to each of a first set of risk relationships and each of a second set of risk relationships. This has already been explained in conjunction with FIG. 3.

Thereafter, at step 408, risk analyzing device 102 identifies one or more risk relationships that include one of a redundancy, an irrelevancy, or an inconsistency. At step 410, risk analyzing device 102 discard the one or more risk relationships identified at step 408 and those risk relationships that have been assigned an impact priority of low impact risk. This has already been explained in detail in conjunction with FIG. 3.

At step 412, risk analyzing device 102 implements incremental intelligence using machine learning techniques for future data analysis. To this end, entire end-to-end system is monitored by an intelligent agent that learns behavior of various consumers logging tickets and existing risk relationships and their processing. In order to learn incrementally to aid actual learning of the system, the intelligent agent captures the complete process that includes creation of multi-dimension risk relationship map, prioritizing and optimizing the risk relationships, receiving a user query, identifying an associated risk, and creating new risk relationship. As a result, risk analyzing device 102 is able to incrementally learn the risk relationships to suggest optimized decision for resolution of risks in the supply chain network. The problem faced by the user can thus be resolved promptly, thereby, improving user experience and increasing efficiency of the supply chain network.

Referring now to FIG. 5, a method of categorizing a user query and creating new risk relationships based on the user query is illustrated, in accordance with an embodiment. At step 502, risk analyzing device 102 receives a user query. The user query denotes the exact problem description that the user is facing. The user query may include, but is not limited to one or more of an audio query and a text query. The user, for example, may log a ticket with the supply chain network. By way of an example, the ticket may read as: “The price of the mobile phone changes day by day.” The ticket may have been logged either verbally through a user utterance on an audio call or may have been inputted in the form of text from a user device. Examples of the user devices may include but are not limited to a computer, a laptop, a mobile device, a tablet, and a phablet.

At step 504, risk analyzing device 102 performs natural language processing and text analysis on the user query. Natural language processing is used mostly to analyze user utterances. Natural language processing may also be applied to speech and text. In an embodiment, when it pertains to email prioritization, natural language processing may include sentence detection, tokenization, sentence tagging, parts of speech tagging, named entity recognition, and co-reference resolution. The natural language processing is used to scan the user query to recognize the necessary nouns, pronouns, and named entities in order to identify the exact problem description that the user is facing. Further, the text analysis is performed to scan content of the user utterance or text written by the user. Text analysis includes performing iterative classification of the user query to determine problem faced by the user based on the contextually relevant keywords. Text analysis also includes ignoring stop words in the user query to determine the problem faced by the user. Examples of stop words include, but are not limited to the, is, at, which, and on.

The natural language processing and the text analysis are performed to derive keywords and co-reference relationship between the keywords, from the user query. By way of an example, when the user query is: “The price of the mobile phone changes day by day,” natural language processing and text analysis identifies the following keywords: price, mobile phone, and change, day by day. The following is also identified:
Nouns: mobile, phone
Co-reference relationship: Price→mobile phone
Adjective: day by day

While deriving keywords and co-reference relationship, stops words in the user query of this example, i.e., “the,” and “of,” are ignored. Moreover, because of the iterative classification, the text analysis algorithm also learns to ignore descriptive words, when one of the examples of that descriptive word is also used in the user query. In continuation of the example above, if the query would have also used the word “Product” along with “Mobile Phone,” the word “Product” being a descriptive word in the example, would have been ignored.

Based on the keywords and the co-reference relationship, risk analyzing device 102 identifies a risk category from the plurality of risk categories, in which the user query should be categorized into at step 506. Each keyword is mapped into each of the plurality of risk categories based on attributes and properties of keywords and risk components in the plurality of risk categories. Further, similarity algorithms are used to calculate distance in order to check which keywords will better fit under which risk components of the plurality of risk categories. Referring back to table 1, there are three risk categories, i.e., Management Related, Internal to Supply Chain, and External to Supply Chain. In continuation of the example above, the keywords (price, mobile phone, change, day by day) do not fit under either of “Internal to Supply Chain” risk category or “External to Supply Chain” risk category, thus “Management Related” is identified as the relevant risk category. Categorizing of the user query into one risk category results in saving time required to perform the analysis, as other risk categories can be ignored and no analysis is required to be performed for these risk categories and the associated risk components.

Once the risk category has been identified, risk analyzing device 102, at step 508, identifies a risk from the user query based on the risk category and the co-reference relationships. To this end, the risk components of the risk category and the risks associated with these risk components are compared by the text analyzer with the co-reference relationship and the keywords to identify the risk. Referring back to table 2, and in continuation of the example above, risk components of the “Management Related” risk category and associated risks are compared with the co-reference relationship, i.e., “Price→mobile phone” and the keywords (price, mobile phone, change, day by day). Based on this comparison, the risk of “Demand variability” under the risk component “Demand” is identified as the risk.

If the identified risk is covered under one or more of the risk relationships within the multi-dimension risk relationship map, these risk relationships are used to identify various other risks or attributes that have an impact on the identified risk. Accordingly, the identified risk is mitigated. However, when the risk is not covered by the risk relationships in the multi-dimensional risk relationship map, risk analyzing device 102 creates one or more new risk relationships at step 510.

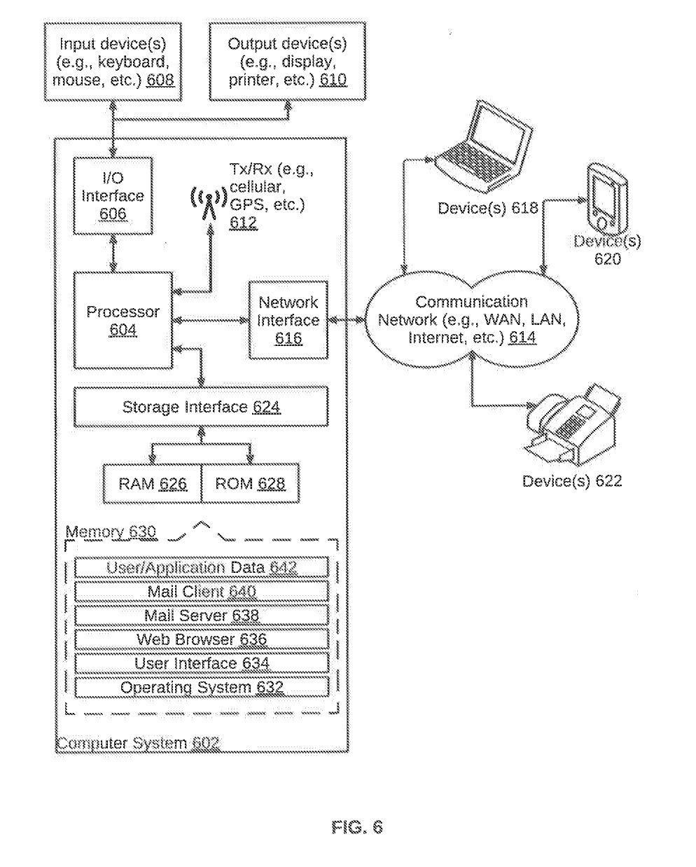

FIG. 6 is a block diagram of an exemplary computer system for implementing various embodiments. Computer system 602 may include a central processing unit (“CPU” or “processor”) 604. Processor 604 may include at least one data processor for executing program components for executing user- or system-generated requests. A user may include a person, a person using a device such as such as those included in this disclosure, or such a device itself. Processor 604 may include specialized processing units such as integrated system (bus) controllers, memory management control units, floating point units, graphics processing units, digital signal processing units, etc. Processor 604 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/O interface 606. I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 606, computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 610 may be a printer, fax machine, video display (e.g., cathode ray tube (CRT), liquid crystal display (LCD), light-emitting diode (LED), plasma, or the like), audio speaker, etc. In some embodiments, a transceiver 612 may be disposed in connection with processor 604. Transceiver 612 may facilitate various types of wireless transmission or reception. For example, transceiver 612 may include an antenna operatively connected to a transceiver chip (e.g., TEXAS® INSTRUMENTS WILINK WL1283® transceiver, BROADCOM® BCM4550IUB8® transceiver, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, processor 604 may be disposed in communication with a communication network 614 via a network Interface 616. Network interface 616 may communicate with communication network 614. Network interface 616 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 614 may include, without limitation, a direct interconnection, local area network (LAN), wide area network (WAN), wireless network (e.g., using Wireless Application Protocol), the Internet, etc. Using network interface 616 and communication network 614, computer system 602 may communicate with devices 618, 620, and 622. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 602 may itself embody one or more of these devices.

In some embodiments, processor 604 may be disposed in communication with one or more memory devices (e.g., RAM 626, ROM 628, etc.) via a storage interface 624. Storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 630 may store a collection of program or database components, including, without limitation, an operating system 632, user interface application 634, web browser 636, mail server 638, mail client 640, user/application data 642 (e.g., any data variables or data records discussed in this disclosure), etc. Operating system 632 may facilitate resource management and operation of computer system 602. Examples of operating systems 632 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT WINDOWS® platform (XP, Vista/7/8, etc.), APPLE® IOS® platform, GOOGLE® ANDROID® platform, BLACKBERRY® OS platform, or the like. User interface 634 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUls) may be employed, including, without limitation, APPLE® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 602 may implement a web browser 636 stored program component. Web browser 636 may be a hypertext viewing application, such as MICROSOFT INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APIs), etc. In some embodiments, computer system 602 may implement a mail server 638 stored program component. Mail server 638 may be an Internet mail server such as MICROSOFT® EXCHANGE® mail server, or the like. Mail server 638 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement a mail client 640 stored program component. Mail client 640 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 602 may store user/application data 642, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments of the invention provide method and device for performing risk analysis using risk relationship mapping in supply chain networks. The proposed method identifies the supply chain risk by its own intelligence from the user query and diagnoses the root cause of the supply chain risk. Therefore, helps in improving profitability of the supply chain network. This method is a great time saving approach as it reduces manual efforts in tracking the customer ticket logs. The system is also an incremental learning system that meets customer satisfaction in a shorter turnaround time.

The specification has described method and device for performing risk analysis using risk relationship mapping in supply chain networks. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of performing risk analysis based on risk relationship mapping in a supply chain network, the method comprising:
creating, by a risk analyzing device, a plurality of risk categories based on a plurality of supply chain inputs within the supply chain network, wherein each of the plurality of risk categories comprise a plurality of risk components, and wherein each of the plurality of risk components has an associated plurality of risks;
creating, by the risk analyzing device, a multi-dimensional risk relationship map for the plurality of risk categories comprising at least one first-dimension and at least one second dimension, wherein each of the at least one first-dimension comprises a first set of risk relationships amongst associated plurality of risks within one of the at least one risk component and each of the at least one second-dimension comprises a second set of risk relationships amongst associated plurality of risks across at least two of the plurality of risk components;
assigning, by the risk analyzing device, an impact priority to each of the first set of risk relationships and each of the second set of risk relationships, wherein an impact priority is assigned to a risk relationship based on impact of the risk relationship on the supply chain network; and
optimizing, by the risk analyzing device, the first set of risk relationships and the second set of risk relationships in response to the assigning.

2. The method of claim 1, wherein optimizing the first set of risk relationships and the second set of risk relationships comprises:
identifying at least one risk relationship that comprises one of a redundancy, an irrelevancy, or an inconsistency, from at least one of the first set of risk relationships or the second set of risk relationships; and
discarding the at least one redundant risk relationship.

3. The method of claim 1, wherein the impact priority comprises one of a high impact risk, a low impact risk, or a medium impact risk.

4. The method of claim 3, wherein optimizing the first set of risk relationships and the second set of risk relationships comprises discarding each risk relationship assigned a low impact risk.

5. The method of claim 1 further comprising:
receiving a user query, the user query comprising at least one of an audio query and a text query;
performing natural language processing and text analysis on the user query to derive keywords and co-reference relationship between the keywords;
categorizing the user query into a risk category selected from the plurality of risk categories based on the keywords and the co-reference relationship; and
identifying a risk from the user query based on the risk category and the co-reference relationship.

6. The method of claim 5 further comprising creating at least one new risk relationship, when the risk is not covered by risk relationships in the multi-dimensional risk relationship map.

7. The method of claim 1, wherein the plurality of supply chain inputs comprises at least one of supply chain contributors, supply chain parameters, or supply chain data sources selected based on the supply chain parameters.

8. The method of claim 7, wherein the supply chain parameters comprises at least one of supply, demand, transportation, process, storage, information, or finance, environment.

9. The method of claim 1, wherein assigning the impact priority comprises identifying risk relationships having one of a direct impact or indirect impact on the supply chain network.

10. The method of claim 1 further comprising implementing incremental intelligence using machine learning techniques for future data analysis.

11. A risk analyzing device for performing risk analysis based on risk relationship mapping in a supply chain network, the risk analyzing device comprises:
a processor; and
a memory communicatively coupled to the processor, wherein the memory stores processor instructions, which, on execution, causes the processor to:
create a plurality of risk categories based on a plurality of supply chain inputs within the supply chain network, wherein each of the plurality of risk categories comprise a plurality of risk components, and wherein each of the plurality of risk components has an associated plurality of risks;
create a multi-dimensional risk relationship map for the plurality of risk categories comprising at least one first-dimension and at least one second dimension, wherein each of the at least one first-dimension comprises a first set of risk relationships amongst associated plurality of risks within one of the at least one risk component and each of the at least one second-dimension comprises a second set of risk relationships amongst associated plurality of risks across at least two of the plurality of risk components;
assign an impact priority to each of the first set of risk relationships and each of the second set of risk relationships, wherein an impact priority is assigned to a risk relationship based on impact of the risk relationship on the supply chain network; and
optimize the first set of risk relationships and the second set of risk relationships in response to the assigning.

12. The risk analyzing device of claim 11, wherein to optimizing the first set of risk relationships and the second set of risk relationships, the processor instructions further cause the processor to:
identify at least one risk relationship that comprises one of a redundancy, an irrelevancy, or an inconsistency, from at least one of the first set of risk relationships or the second set of risk relationships; and
discard the at least one redundant risk relationship.

13. The risk analyzing device of claim 1, wherein the impact priority comprises one of a high impact risk, a low impact risk, or a medium impact risk.

14. The risk analyzing device of claim 13, wherein to optimize the first set of risk relationships and the second set of risk relationships, the processor instructions further cause the processor to discard each risk relationship assigned a low impact risk.

15. The risk analyzing device of claim 11, wherein the processor instructions further cause the processor to:
receive a user query, the user query comprising at least one of an audio query and a text query;
perform natural language processing and text analysis on the user query to derive keywords and co-reference relationship between the keywords;
categorize the user query into a risk category selected from the plurality of risk categories based on the keywords and the co-reference relationship; and
identify a risk from the user query based on the risk category and the co-reference relationship.

16. The risk analyzing device of claim 15, wherein the processor instructions further cause the processor to create at least one new risk relationship, when the risk is not covered by risk relationships in the multi-dimensional risk relationship map.

17. The risk analyzing device of claim 11, wherein the plurality of supply chain inputs comprises at least one of supply chain contributors, supply chain parameters, or supply chain data sources selected based on the supply chain parameters.

18. The risk analyzing device of claim 17, wherein the supply chain parameters comprises at least one of supply, demand, transportation, process, storage, information, or finance, environment.

19. The risk analyzing device of claim 11, wherein to assign the impact priority, the processor instructions further cause the processor to identify risk relationships having one of a direct impact or indirect impact on the supply chain network.

20. A non-transitory computer-readable storage medium having stored thereon, a set of computer-executable instructions causing a computer comprising one or more processors to perform steps comprising:
creating, by a risk analyzing device, a plurality of risk categories based on a plurality of supply chain inputs within the supply chain network, wherein each of the plurality of risk categories comprise a plurality of risk components, and wherein each of the plurality of risk components has an associated plurality of risks;
creating, by the risk analyzing device, a multi-dimensional risk relationship map for the plurality of risk categories comprising at least one first-dimension and at least one second dimension, wherein each of the at least one first-dimension comprises a first set of risk relationships amongst associated plurality of risks within one of the at least one risk component and each of the at least one second-dimension comprises a second set of risk relationships amongst associated plurality of risks across at least two of the plurality of risk components;
assigning, by the risk analyzing device, an impact priority to each of the first set of risk relationships and each of the second set of risk relationships, wherein an impact priority is assigned to a risk relationship based on impact of the risk relationship on the supply chain network; and
optimizing, by the risk analyzing device, the first set of risk relationships and the second set of risk relationships in response to the assigning.
